(19) United States
(12) Patent Application Publication
(10) Pub. No.: US 2011/0205551 A1
(43) Pub. Date: Aug. 25, 2011

(54) VARIABLE WAVELENGTH INTERFERENCE FILTER, OPTICAL SENSOR, AND ANALYTICAL INSTRUMENT

(75) Inventors: Daisuke SAITO, Matsumoto (JP); Seiji YAMAZAKI, Fujimi (JP)

(73) Assignee: SEIKO EPSON CORPORATION, Tokyo (JP)

(21) Appl. No.: 12/984,031

(22) Filed: Jan. 4, 2011

(30) Foreign Application Priority Data
Feb. 19, 2010 (JP) 2010-034380

(51) Int. Cl. G01B 9/02; G02B 5/28

(52) U.S. Cl. 356/519; 359/578

(57) ABSTRACT

A variable wavelength interference filter includes: a first substrate having a light transmissive property; a second substrate opposed to and bonded to one surface of the first substrate; a first reflecting film disposed on the one surface of the first substrate; a second reflecting film disposed on a first surface of the second substrate opposed to the first substrate, and opposed to the first reflecting film via a gap; and a variable section adapted to vary the gap, wherein the second substrate includes a light transmission opening disposed at a position opposed to the first reflecting film, and penetrating through the second substrate from the first surface to the second surface on the opposite side, and a planar transmissive member opposed to the first substrate and adapted to close the light transmission opening.

### BACKGROUND

1. Technical Field

The present invention relates to a variable wavelength interference filter, an optical sensor, and an analytical instrument.

2. Related Art

In the past, there has been known a variable wavelength interference filter having mirrors respectively disposed on surfaces of a pair of glass substrates, the surfaces being opposed to each other. In such a variable wavelength interference filter, a light beam is reflected between the pair of mirrors to transmit only a light beam with a specific wavelength and to make the other light beams with other wavelengths cancel out each other by interference, thereby transmitting only the light beam with a specific wavelength out of the incident light beam.

Further, the variable wavelength interference filter controls the distance (the gap) between the pair of mirrors to thereby select the wavelength of the light beam of the specific wavelength described above to be transmitted. In order for achieving this operation, at least either one of the pair of glass substrates is processed by etching to form a diaphragm, and a driver such as an electrostatic actuator is disposed between the pair of glass substrates. According to such a configuration, by controlling the driver it becomes possible to displace the diaphragm in the direction in which the glass substrates are stacked on each other, and thus it becomes possible to selectively transmit the light beam with a desired wavelength.

However, in the case of forming the diaphragm by processing the glass substrates by etching as described above, the time required for etching increases, which makes the manufacturing process cumbersome and complicated. Further, since the etching accuracy is not so high in the etching of the glass substrates, fluctuation is caused in the evenness of the diaphragm, which might affect the spectral accuracy.

In contrast thereto, there is known a variable wavelength interference filter using silicon substrates, which allow reduction of the etching time in the manufacturing process and can provide high etching accuracy, instead of the glass substrates (see, e.g., JP-A-2006-23606 (Document 1)).

The variable wavelength interference filter described in Document 1 is a variable wavelength interference filter having a fixed substrate and a movable substrate bonded to each other. The fixed substrate is provided with two cylindrical recessed sections formed on the surface thereof opposed to the movable substrate, and these recessed sections are provided with a fixed reflecting film and a conductive layer.

Further, the movable substrate is made of a conductive silicon substrate, and is provided with a movable section disposed at a rough center of the movable substrate, a support section disposed in the outer peripheral section of the movable section and for movably holding the movable section, and a conducting section for providing electricity to the movable section. Further, since the silicon substrates do not have a transmissive property to visible light beams, the movable section is provided with a light transmission section having a cylindrical inner circumferential surface formed at a rough center of the movable section, and a glass member is inserted in the light transmission section. Further, the surface of the movable section opposed to one of the recessed sections of the fixed substrate is provided with a movable reflecting film.

Incidentally, when the movable substrate is deflected toward the side of the fixed substrate, the portion of the movable substrate located on the side of the fixed substrate from a thickness center position of the movable substrate is expanded toward the periphery of the surface while the portion on the light entrance side, the opposite side, is shrunk toward the inside of the surface.

Therefore, in the variable wavelength interference filter of the related art described in Document 1, the pressing force in the inward radial direction acts on the glass inside the light transmission section on the entrance side of the light transmission section, and thus the glass might be broken.

### SUMMARY

An advantage of some aspects of the invention is to provide a variable wavelength interference filter, an optical sensor, and an analytical instrument each having high accuracy and long life.

According to an aspect of the invention, there is provided a variable wavelength interference filter including a first substrate having a light transmissive property, a second substrate opposed to and bonded to one surface of the first substrate, a first reflecting film disposed on the one surface of the first substrate, a second reflecting film disposed on a first surface of the second substrate opposed to the first substrate, and opposed to the first reflecting film via a gap, and a variable section adapted to vary the gap, wherein the second substrate includes a light transmission opening disposed at a position opposed to the first reflecting film, and penetrating through the second substrate from the first surface to the second surface on the opposite side, and a planar transmissive member opposed to the first substrate and adapted to close the light transmission opening.

According to this aspect of the invention, the variable section deflects the second substrate to come closer to the first substrate, thereby varying the gap between the first reflecting film and the second reflecting film. On this occasion, it results that the distortion is caused in the shape of the light transmission opening due to the deflection of the second substrate. Specifically, the light transmission opening is distorted in a direction of increasing the diameter thereof on the side of the first surface while decreasing the diameter thereof on the side of the second surface.

Here, if the transmissive member is provided to the light transmission opening on the side of the second surface of the second substrate, lateral pressure acts on the transmissive member when the second surface side of the light transmission opening is distorted due to the deflection of the second substrate, and the transmissive member might be broken. In contrast, in the invention the plate-like transmissive member is disposed at the first surface side of the light transmission opening. Therefore, no lateral pressure acts on the transmissive member, and the problem of the breakage of the transmissive member does not occur. Therefore, it becomes possible to lengthen the product life of the variable wavelength interference filter.

Further, since it results that the transmissive member disposed at the first surface side of the light transmission opening receives the tensile stress from the second substrate, there is no possibility of causing the deflection or distortion, and therefore the first reflecting film and the second reflecting film can be maintained in parallel to each other. Therefore, the spectral resolution of the light beam taken out by the variable wavelength interference filter can be maintained, and thus the preferable spectral accuracy can be maintained.

In the variable wavelength interference filter according to the above aspect of the invention, it is preferable to have a configuration in which the second reflecting film is disposed in a plane of a surface opposed to the first substrate of the transmissive member.

According to this configuration, it is possible to prevent the deflection of the second reflecting film, and to maintain the parallel relationship between the first reflecting film and the second reflecting film. Specifically, if the second substrate is deflected toward the first substrate, a gap or a step might be caused between the surface (hereinafter referred to as a light exit surface) of the transmissive member opposed to the first substrate and the first surface of the second substrate. Therefore, in the case in which the second reflecting film is formed so as to straddle the light exit surface of the transmissive member and the first surface of the second substrate, there is a possibility that the second reflecting film is distorted due to the gap or the step described above, and the parallel relationship with the first reflecting film becomes difficult to maintain. In contrast thereto, by disposing the second reflecting film in the plane of the light exit surface of the transmissive member as in the invention, even if the gap or the step described above is caused, the gap or the step does not have any influence thereon, and the second reflecting film is never deflected.

Further, although the first surface forms a downwardly-convex quadratic surface when the second substrate is deflected, by using a material with a hardness higher than the second substrate such as glass as the transmissive member, it becomes also possible to efficiently prevent the distortion of the transmissive member. In this case, by disposing the second reflecting film in the light exit surface of the transmissive member, the distortion of the second reflecting film can also be prevented, and improvement of the spectral accuracy can be achieved.

In the variable wavelength interference filter according to the above aspect of the invention, it is preferable to have a configuration in which the first surface of the second substrate is provided with a recessed section adapted to house the light transmissive member, formed along a circumferential edge of the light transmission opening, and a plane of the light transmissive member opposed to the first substrate and the first surface of the second substrate are coplanar with each other.

According to this configuration, since the recessed section is provided to the light transmission opening on the side of the first surface of the second substrate, and the transmissive member is housed inside the recessed section, the transmissive member does not protrude from the first surface of the second substrate. Therefore, in the initial state in which the second substrate is not deflected toward the first substrate, the dimension of the gap can be set larger to make it possible to disperse the light beam in a broader wavelength range.

In the variable wavelength interference filter according to the above aspect of the invention, it is preferable to have a configuration in which the light transmissive member is made of glass having a movable ion, the second substrate has a conductive property, and the transmissive member and the second substrate are bonded to each other by anodic bonding.

According to this configuration, the second substrate and the transmissive member are bonded to each other by anodic bonding. In the anodic bonding process, a negative voltage is applied to the glass under the high temperature at which the movable ions (e.g., sodium ions) in glass migrate easily, thereby making the movable ions migrate from the surface of the glass member to thereby generate the electrostatic force, and thus the transmissive member and the second substrate are bonded to each other. According to such an anodic bonding process, the second substrate and the transmissive member can directly be bonded to each other with high bonding strength.

Therefore, compared to the case of bonding the second substrate and the transmissive member via a bonding layer such as an adhesive, the second substrate and the transmissive member can be bonded to each other in parallel to each other with accuracy, thus the spectral accuracy of the variable wavelength interference filter can further be improved.

In the variable wavelength interference filter according to the above aspect of the invention, it is preferable to have a configuration in which the first substrate is made of glass having a movable ion, the second substrate has a conductive property, and the first substrate and the second substrate are bonded to each other by anodic bonding.

Here, as the second substrate there can be adopted, for example, a conductive metal substrate such as a silicon substrate and a substrate provided with a conductive film (e.g., a metal thin film) deposited on the surface to be bonded to the first substrate.

According to this configuration, the first substrate and the second substrate are bonded to each other by anodic bonding. In the anodic bonding process, a negative voltage is applied to the glass under the high temperature at which the movable ions (e.g., sodium ions) in glass migrate easily, thereby making the movable ions migrate from the surface of the glass member to thereby generate the electrostatic force, and thus the transmissive member and the second substrate are bonded to each other. According to such an anodic bonding process, the first substrate and the second substrate can directly be bonded to each other with high bonding strength.

Therefore, compared to the case of bonding the first substrate and the second substrate via a bonding layer such as an adhesive, the first substrate and the second substrate can be bonded to each other in parallel to each other with accuracy, thus the spectral accuracy of the variable wavelength interference filter can further be improved.

In the variable wavelength interference filter according to the above aspect of the invention, it is preferable to have a configuration in which the second substrate is made of silicon.

According to this configuration, silicon is selected as a material of the second substrate. Silicon can be etched easily and promptly by crystal anisotropic etching compared to, for example, glass or the like, and can be etched with accuracy by anisotropic etching. Therefore, by selecting silicon as the material of the second substrate, improvement of the etching accuracy and reduction of the etching time can be achieved when performing etching on the second substrate.

Therefore, it becomes easy to process the second substrate, and the productivity of the variable wavelength interference filter can be improved.

According to another aspect of the invention, there is provided an optical sensor including any of the variable wavelength interference filters described above, and a light receiving section adapted to receive a test target light beam transmitted through the variable wavelength interference filter.

According to this aspect of the invention, as described above, since the variable wavelength interference filter does not have the transmissive member disposed in the light transmission opening on the side of the second surface of the second substrate, there is no possibility that the transmissive member is broken due to the pressing force acting on the transmissive member in the inward radial direction caused by the stress concentration. Further, there is no possibility of causing the deflection or distortion in the transmissive member. There is no possibility of causing the variation in the gap between the first reflecting film and the second reflecting film, and therefore, the spectral accuracy of the variable wavelength interference filter can be maintained.

By receiving the light beam emitted from such a variable wavelength interference filter by the light receiving section, the optical sensor can measure the accurate light intensity of the light component with a desired wavelength included in the test target light beam.

According to still another aspect of the invention there is provided an analytical instrument including the optical sensor according to the above aspect of the invention.

According to this aspect of the invention, as described above, since the variable wavelength interference filter does not have the transmissive member disposed in the light transmission opening on the side of the second surface of the second substrate, there is no possibility that the transmissive member is broken due to the pressing force acting on the transmissive member in the inward radial direction caused by the stress concentration. Further, there is no possibility of causing the deflection or distortion in the transmissive member. There is no possibility of causing the variation in the gap between the first reflecting film and the second reflecting film, and therefore, the spectral accuracy of the variable wavelength filter can be maintained. Therefore, in the light receiving section of the optical sensor, the light intensity of the light beam with the desired wavelength included in the test target light beam can accurately be detected. Therefore, also in the processing section, analysis can be performed with accuracy based on the accurate light intensity of the light beam with the desired wavelength included in the test target light beam.

### BRIEF DESCRIPTION OF THE DRAWINGS

The invention will be described with reference to the accompanying drawings, wherein like numbers reference like elements.

FIG. 1 is a diagram showing a schematic configuration of an analytical instrument according to an embodiment of the invention.

FIG. 2 is a plan view showing a schematic configuration of an etalon constituting a variable wavelength interferential filter according to the embodiment.

FIG. 3 is a cross-sectional view of the etalon shown in FIG. 2 when cutting the etalon along the line.

FIGS. 4A through 4D are diagrams showing a manufacturing process of a first substrate of the etalon, wherein FIG. 4A is a schematic diagram of a resist formation process for providing a resist for forming a mirror fixation surface to the first substrate, FIG. 4B is a schematic diagram of a first groove formation process for forming a mirror fixation surface, FIG. 4C is a schematic diagram of a second groove formation process for forming an electrode fixation surface, and FIG. 4D is a schematic diagram of an AgC formation process for forming an AgC layer.

FIGS. 5A through 5F are diagrams schematically showing a manufacturing process of a second substrate, wherein FIG. 5A is a schematic diagram of a glass precursor formation process for forming a glass precursor by etching a transmissive substrate, FIG. 5B is a schematic diagram of a recessed section formation process for forming a recessed section by performing Si-etching using an SiO₂ etching pattern provided to the second substrate, FIG. 5C is a schematic diagram of an anodic bonding process for performing the anodic bonding between the second substrate and the transmissive substrate while fitting the glass precursor and the recessed section to each other, FIG. 5D is a schematic diagram of a polishing process for polishing the transmissive substrate to the bonding surface with the second substrate, FIG. 5E is a schematic diagram of a movable section/connection holding section/light transmission opening formation process for forming a movable section, a connection holding section, and a light transmission opening by performing Si-etching using an SiO₂ etching pattern provided to the second substrate, and FIG. 5F is a schematic diagram of an electrode/mirror formation process for providing a second displacing electrode and a movable mirror.

### DESCRIPTION OF EXEMPLARY EMBODIMENTS

A colorimetric module according to an embodiment of the invention will hereinafter be explained with reference to the accompanying drawings.

### 1. Overall Configuration of Analytical Instrument

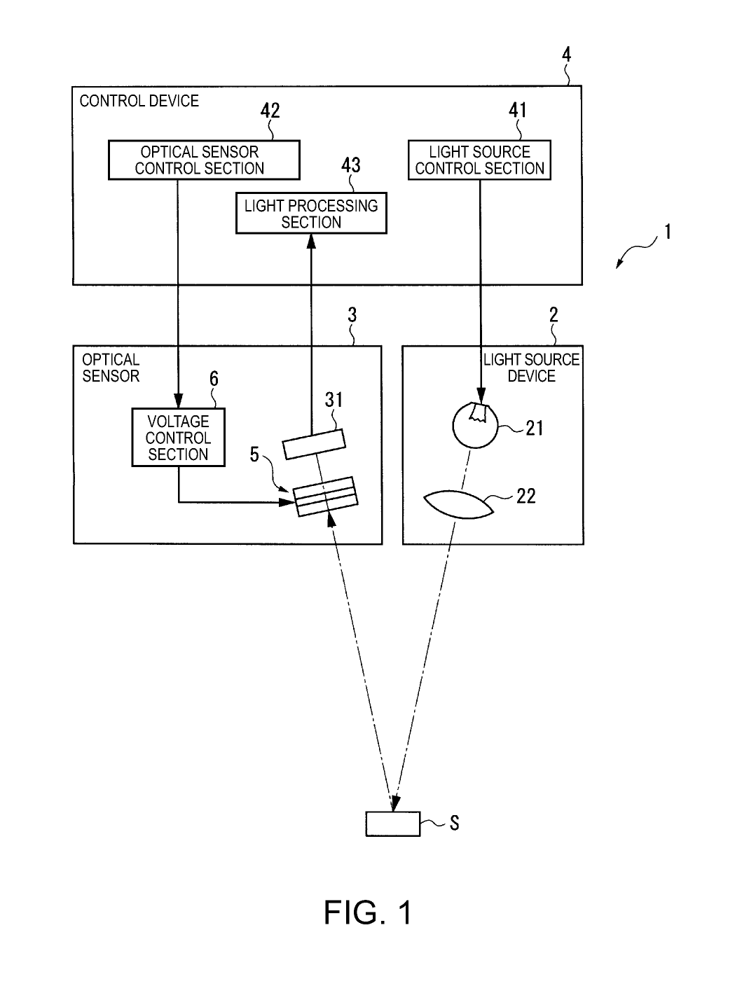

FIG. 1 is a diagram showing a schematic configuration of an analytical instrument according to an embodiment of the invention.

As shown in FIG. 1, the analytical instrument 1 is provided with a light source device 2 for emitting light beam to a test object S, an optical sensor 3 according to the invention, and a control device 4 for controlling an overall operation of the analytical instrument 1. Further, the analytical instrument 1 is an analytical instrument for making the light beam, which is emitted from the light source device 2, be reflected by the test object S, receiving the test target light beam obtained by the reflection using the optical sensor 3, and analyzing the test target light beam based on the detection signal output from the optical sensor 3.

### 2. Configuration of Light Source Device

The light source device 2 is provided with a light source 21 and a plurality of lenses 22 (one of the lenses is shown in FIG. 1), and emits a white light beam to the test object S. Further, the plurality of lenses 22 includes a collimator lens, and the light source device 2 modifies the white light beam emitted from the light source 21 into a parallel light beam with the collimator lens, and emits it from the projection lens not shown to the test object S.

### 3. Configuration of Optical Sensor

As shown in FIG. 1, the optical sensor 3 is provided with an etalon 5 constituting the variable wavelength interference filter according to the invention, a light receiving element 31 as a light receiving section for receiving the light beam emitted through the etalon 5, and a voltage control section 6 for varying the wavelength of the light beam transmitted through the etalon 5. Further, the optical sensor 3 is provided with an entrance optical lens not shown disposed at a position opposed to the etalon 5, the entrance optical lens guiding the reflected light beam (the test target light beam) reflected by the test object S into the inside thereof. Further, the optical sensor 3 disperses only the light beam with a predetermined wavelength out of the test target light beam entering from the entrance optical lens using the etalon 5, and then receives the light beam thus dispersed using the light receiving element 31.

The light receiving element 31 is composed of a plurality of photoelectric conversion elements, and generates an electric signal corresponding to the received light intensity. Further, the light receiving element 31 is connected to the control device 4, and outputs the electric signal thus generated to the control device 4 as a light reception signal.

### 3-1. Configuration of Etalon

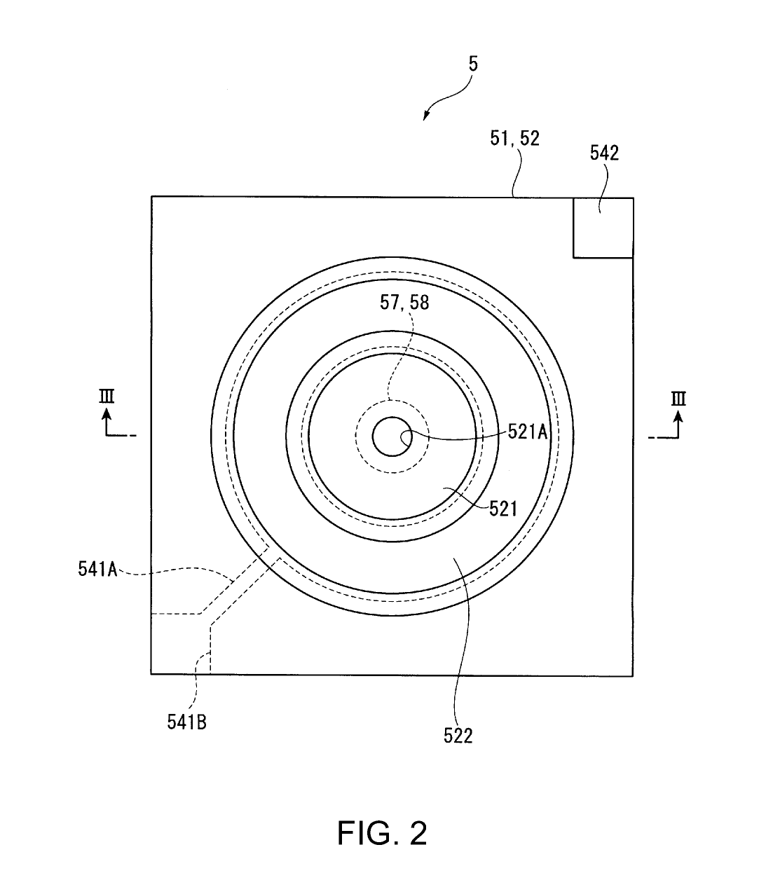

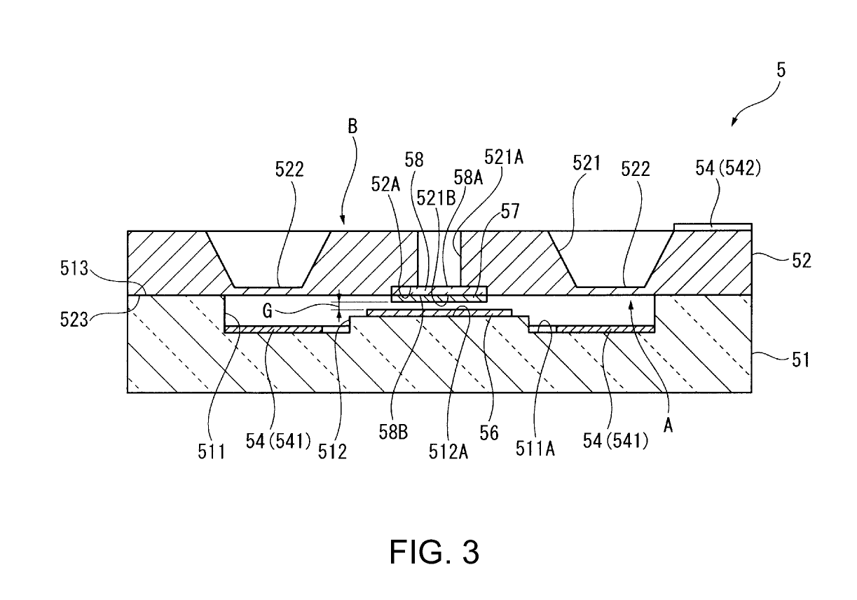

FIG. 2 is a plan view showing a schematic configuration of the etalon 5 constituting the variable wavelength interference filter according to the invention, and FIG. 3 is a cross-sectional diagram showing the schematic configuration of the etalon 5. It should be noted that although in FIG. 1 the test target light beam enters the etalon 5 from the lower side of the drawing, in FIG. 3 it is assumed that the test target light beam enters it from the left side of the drawing.

As shown in FIG. 2, the etalon 5 is a plate-like optical member having a square planar shape formed to have each side of, for example, 10 mm. As shown in FIG. 3, the etalon 5 is provided with a fixed substrate 51 and a movable substrate 52. The fixed substrate 51 is made of glass of various types such as soda glass, crystalline glass, quartz glass, lead glass, potassium glass, borosilicate glass, or alkali-free glass, or quartz crystal, for example. Among these materials, a glass containing alkali metal such as sodium or potassium is preferable for the constituent material of the fixed substrate 51, and by making the fixed substrate 51 of such glass, it becomes possible to enhance the adhesiveness of fixed mirror 56 described later and the electrodes, and the bonding strength between the substrates. Further, as a constituent material of the movable substrate 52, a conductive material is used, and silicon is preferably used, for example. By forming the movable substrate 52 of silicon, it becomes possible to enhance the etching accuracy and to reduce the etching time. Further, these two substrates 51, 52 are formed integrally by performing anodic bonding between the bonding surfaces 513, 523 formed in the vicinities of the outer peripheral portions.

Further, a fixed mirror 56 as a first reflecting film according to the invention and a movable mirror 57 as a second reflecting film are disposed between the fixed substrate 51 and the movable substrate 52. Here, the fixed mirror 56 is fixed to a surface of the fixed substrate 51 opposed to the movable substrate 52, and the movable mirror 57 is fixed to a surface of the movable substrate 52 opposed to the fixed substrate 51. Further, the fixed mirror 56 and the movable mirror 57 are disposed so as to opposed to each other via an inter-mirror gap G as a gap.

Further, an electrostatic actuator 54 as a variable section for controlling the dimension of the inter-mirror gap G between the fixed mirror 56 and the movable mirror 57 is disposed between the fixed substrate 51 and the movable substrate 52.

### 3-1-1. Configuration of Fixed Substrate

The fixed substrate 51 is formed by processing a glass substrate formed to have a thickness of, for example, 500 μm using an etching process. Specifically, as shown in FIG. 3, the fixed substrate 51 is provided with an electrode formation groove 511 and a mirror fixation section 512 by etching.

The electrode formation groove 511 is formed to have a circular shape centered on a center point of the plane in a plan view (hereinafter referred to as an etalon-plan view) in which the etalon 5 is viewed in the thickness direction, as shown in FIG. 2. The mirror fixation section 512 is formed so as to protrude toward the side of the movable substrate 52 from the center portion of the electrode formation groove 511 in the plan view described above.

The electrode formation groove 511 is provided with an electrode fixation surface 511A having a ring-like shape formed between the outer circumferential edge of the mirror fixation section 512 and the internal circumferential wall surface of the electrode formation groove 511, and the electrode fixation surface 511A is provided with a first displacing electrode 541. Further, in the etalon-plan view shown in FIG. 2, a first displacing electrode leading section 541A is formed so as to extend from a part of the outer circumferential edge of the first displacing electrode 541 toward one (in the lower left direction in the example shown in FIG. 2) of the apexes of the etalon 5. Further, at the tip of the first displacing electrode leading section 541A, there is formed a first displacing electrode pad 541B, and the first displacing electrode pad 541B is connected to the voltage control section 6.

As described above, the mirror fixation section 512 is formed to have a columnar shape coaxial with the electrode formation groove 511 and having a radial dimension smaller than the electrode formation groove 511. It should be noted that although in the present embodiment there is shown an example in which the mirror fixation surface 512A of the mirror fixation section 512 opposed to the movable substrate 52 is formed nearer to the movable substrate 52 than the electrode fixation surface 511A as shown in FIG. 3, the structure is not limited thereto. The height positions of the electrode fixation surface 511A and the mirror fixation surface 512A are arbitrarily set in accordance with the dimension of the inter-mirror gap G between the fixed mirror 56 fixed to the mirror fixation surface 512A and the movable mirror 57 formed on the movable substrate 52, the dimension of a gap between the first displacing electrode 541 and the movable electrode 52 opposed to the first displacing electrode 541, and the thickness dimensions of the fixed mirror 56 and the movable mirror 57, and are not limited to those of the configuration described above. In the case in which dielectric multilayer film mirrors are used as the mirrors 56, 57, and the thickness dimensions thereof are increased, for example, it is also possible to adopt, for example, the configuration of forming the electrode fixation surface 511A and the mirror fixation surface 512A in the same plane, or the configuration in which the mirror fixation groove having a columnar groove shape is formed at the center portion of the electrode fixation surface 511A, and the mirror fixation surface 512A is formed on the bottom of the mirror fixation groove.

Further, it is preferable that the groove depth of the mirror fixation surface 512A of the mirror fixation section 512 is designed taking the wavelength range of the light beam to be transmitted through the etalon 5 into consideration. For example, in the present embodiment an initial value (the dimension of the inter-mirror gap G in the state in which no voltage is applied between the first displacing electrode 541 and a second displacing electrode 542) of the inter-mirror gap G between the fixed mirror 56 and the movable mirror 57 is set to 450 nm, and it is arranged that the movable mirror 57 can be displaced up to the position where the inter-mirror gap G becomes, for example, 250 nm by applying the voltage between the first displacing electrode 541 and the second displacing electrode 542, and thus, it becomes possible to selectively disperse the light beam with the wavelength in the entire visible light range by varying the voltage applied between the first displacing electrode 541 and the second displacing electrode 542. In this case, it is enough for the film thicknesses of the fixed mirror 56 and the movable mirror 57, and the height dimensions of the mirror fixation surface 512A and the electrode fixation surface 511A to beset to the values with which the inter-mirror gap G can be displaced between 250 nm and 450 nm.

Further, the fixed mirror 56 formed to have a circular shape with a diameter of about 3 mm is fixed to the mirror fixation surface 512A. The fixed mirror 56 is a mirror formed of a single layer of AgC, and is formed on the mirror fixation surface 512A using a method such as sputtering.

It should be noted that although in the present embodiment there is shown an example of using the mirror of the AgC single layer, which is capable of covering the entire visible light range as the wavelength range the etalon 5 can disperse, as the fixed mirror 56, the configuration is not limited thereto. For example, there can be adopted the configuration of using, for example, a TiO₂—SiO₂ dielectric multilayer film mirror having a narrow wavelength range the etalon 5 can disperse, a larger transmittance of the light beams obtained by the dispersion, and a narrower half-value width of transmittance and more preferable resolution than those of the AgC single layer mirror. It should be noted that on this occasion as described above, it is necessary to appropriately set the height positions of the mirror fixation section 512A and the electrode fixation surface 511A of the fixed substrate 51 by the fixed mirror 56, the movable mirror 57, and the wavelength selection range of the light beam to be dispersed.

Further, the fixed substrate 51 is provided with an antireflection film (AR) not shown formed at a position corresponding to the fixed mirror 56 on the lower surface on the opposite side to the upper surface opposed to the movable substrate 52. The antireflection film is formed by alternately stacking low refractive index films and high refractive index films, decreases the reflectance of the visible light on the surface of the fixed substrate 51, and increases the transmittance.

### 3-1-2. Configuration of Movable Substrate

The movable substrate 52 is formed by processing a silicon substrate formed to have a thickness of, for example, 200 μm using an etching process.

Specifically, the movable substrate 52 is provided with a movable section 521 having a circular shape centered on the center point of the substrate in the plan view shown in FIG. 2, and a connection holding section 522 coaxial with the movable section 521 and for holding the movable section 521.

As shown in FIG. 3, the movable section 521 is formed to have a thickness dimension larger than that of the connection holding section 522, and is formed in the present embodiment, for example, to have the thickness dimension of 200 μm, the same dimension as the thickness dimension of the movable substrate 52. Further, although the silicon substrate is used as the movable substrate 52, the substrate is not limited thereto, but any substrate having conductivity and easily processed and formed by etching can also be adopted.

Further, the movable section 521 has a light transmission opening 521A coaxial with the movable section 521 in the plan view shown in FIG. 2. The light transmission opening 521A penetrates the movable substrate 52 from the first surface A to the second surface B thereof. Further, the light transmission opening 521A is provided with a recessed section 52A for housing a glass member 58 as a transmissive member formed on the side of the first surface A. The glass member 58 is formed to have a plate-like shape having a light entrance surface 58A parallel to the fixed mirror 56 and a light exit surface 58B parallel to the fixed mirror, and is bonded to the bottom surface of the recessed section 52A by anodic bonding.

The thickness of the glass member 58 is preferably in a range of 20 through 50 μm, and is further preferably 35 μm. In the case in which the thickness dimension of the glass member 58 is smaller than 20 μm, when the first surface side of the light transmission opening 521A is pulled in the outward radial direction, breakage might be caused by the pull force although no deflection is caused in the glass member 58.

On the other hand, if the thickness dimension of the glass member 58 is larger than 50 μm, the glass member 58 might be deflected. Specifically, in the configuration in which the light entrance surface 58A of the glass member 58 is bonded to the bottom surface of the recessed section 52A, the pull force toward the outer radial direction acts on the light entrance surface 58A of the glass member 58 due to the deflection of the movable substrate 52. Here, if the thickness dimension of the glass member 58 is not larger than 50 μm, the pull force acting on the light entrance surface 58A of the glass member 58 propagates to the side of the light exit surface 58B to expand the light entrance surface 58A and the light exit surface 58B as much as amounts substantially equivalent to each other, and the deflection of the glass member 58 almost vanishes. On the other hand, if the thickness dimension of the glass member 58 is larger than 50 μm, the pull force does not reach the side of the light exit surface 58B, and the light entrance surface 58A is expanded alone, which might cause the convex deflection toward the side of the light transmission opening 521A as a whole.

In contrast, by forming the glass member 58 so as to have the thickness dimension in a range of 20 through 50 μm, the problems such as the breakage or deflection of the glass member 58 described above can be prevented.

Further, the glass member 58 is preferably made of heat-resistant hard glass specifically having thermal conductivity preferably not lower than 1.0 (W·m¹·K⁻¹). In other words, when bonding the glass member 58 to the movable substrate 52 by anodic bonding, a heating process of heating the glass member 58 to about 400 degrees is required. Therefore, it is preferable to have the thermal conductivity with which the glass member 58 can bear with the heating process, and thus the glass member 58 with the thermal conductivity not lower than 1.0 (W·m⁻¹·K⁻¹) is used.

Further, it is also possible to bond the glass member 58 to the movable substrate 52 without using anodic bonding, the glass member 58 with the thermal conductivity lower than 1.0 (W·m⁻¹·K⁻¹) has a higher probability of the breakage due to the application of the pull force as described above.

As a material of such a heat-resistant glass member 58, there can be cited, for example, Pyrex (registered trademark of Corning Glass Works) glass. It should be noted that the transmissive member is not limited to the glass member 58, but a light transmissive resin member, which is not broken nor deformed by the pull force transmitted from the movable substrate 52, and can be bonded to the movable substrate 52 with preferable bond strength, can also be used therefor.

Further, the movable mirror 57 is provided in the plane of the light exit surface 58B of the glass member 58, and a pair of mirrors 56, 57 parallel to each other is composed of the fixed mirror 56 and the movable mirror 57 described above. Further, in the present embodiment, the inter-mirror gap G between the movable mirror 57 and the fixed mirror 56 is set to 450 nm in the initial state.

Here, a mirror having the configuration identical to that of the fixed mirror 56 described above is used as the movable mirror 57, and in the present embodiment, the AgC single layer mirror is used. Further, the AgC single layer mirror is formed to have a film thickness dimension of, for example, 0.03 μm.

Further, the movable section 521 is provided with an antireflection film (AR) not shown formed at a position corresponding to the movable mirror 57 on the upper surface thereof on the side opposite to the movable mirror surface 521B. The antireflection film has a configuration substantially identical to that of the antireflection film provided to the fixed substrate 51, and is formed by alternately stacking low refractive index films and high refractive index films.

The connection holding section 522 is a diaphragm surrounding the periphery of the movable section 521, and is formed to have a thickness dimension of, for example, 50 μm. Further, the second displacing electrode 542 is disposed at one (located in an upper right direction in the example shown in FIG. 2) of the apexes on the second surface B of the movable substrate 52.

### 3-2. Configuration of Voltage Control Section

The voltage control section 6 constitutes the variable wavelength interference filter according to the invention together with the etalon 5 described above. The voltage control section 6 controls the voltages to be applied to the first displacing electrode 541 and the second displacing electrode 542 of the electrostatic actuator 54 based on the control signal input from the control device 4.

It should be noted that although the number of first displacing electrode pads 541B is assumed to be one, the number is not limited to one, but it is possible to provide two or more first displacing electrode pads 541B. In this case, it is possible to use one thereof as an application electrode, and the other thereof as a detecting electrode. Further, the same can be applied to the second displacing electrode 542.

### 4. Configuration of Control Device

The control device 4 controls overall operations of the analytical instrument 1.

As the control device 4, a general-purpose personal computer, a handheld terminal, a colorimetric-dedicated computer, and so on can be used.

Further, as shown in FIG. 1, the control device 4 is configured including a light source control section 41, an optical sensor control section 42, a light processing section 43, and so on.

The light source control section 41 is connected to the light source device 2. Further, the light source control section 41 outputs a predetermined control signal to the light source device 2 based on, for example, a setting input by the user to thereby make the light source device 2 emit a white light beam with a predetermined brightness.

The optical sensor control section 42 is connected to the optical sensor 3. Further, the optical sensor control section 42 sets the wavelength of the light beam to be received by the optical sensor 3 based on the setting input by the user, for example, and then outputs the control signal for detecting the intensity of the received light with this wavelength to the optical sensor 3. Thus, the voltage control section 6 of the optical sensor 3 sets the application voltage to the electrostatic actuator 54 based on the control signal so as to transmit only the light beam with the wavelength desired by the user.

Here, in the present embodiment the electrostatic actuator 54 deflects the movable substrate 52 to come closer to the fixed substrate 51, thereby varying the inter-mirror gap G between the fixed mirror 56 and the movable mirror 57. On this occasion, it results that the distortion is caused in the shape of the light transmission opening 521A due to the deflection of the movable substrate 52. Specifically, the light transmission opening 521A is distorted in a direction of increasing the diameter thereof on the side of the first surface A while decreasing the diameter thereof on the side of the second surface B.

On this occasion, since the glass member 58 is not provided to the side of the second surface B of the light transmission opening 521A of the movable substrate 52, there is nothing to restrict the distortion in the direction of decreasing the diameter thereof. Further, since it results that the plate-like glass member 58 disposed on the side of the first surface A of the light transmission opening 521A receives tensile stress from the movable substrate 52, there is caused no deflection nor distortion.

### 5. Method of Manufacturing Etalon

Then, a method of manufacturing etalon 5 will be explained with reference to the drawings.

### 5-1. Manufacture of Fixed Substrate

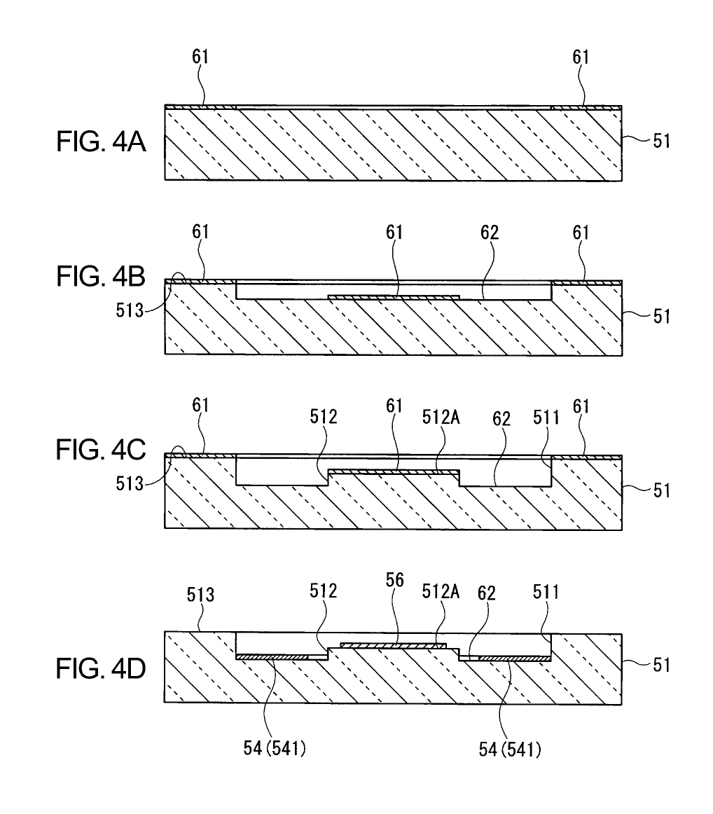

FIGS. 4A through 4D are diagrams showing a manufacturing process of a first substrate of the etalon 5, wherein FIG. 4A is a schematic diagram of a resist formation process for providing a resist for forming a mirror fixation surface 512A to the fixed substrate 51, FIG. 4B is a schematic diagram of a first groove formation process for forming the mirror fixation surface 512A, FIG. 4C is a schematic diagram of a second groove formation process for forming an electrode fixation surface 511A, and FIG. 4D is a schematic diagram of an AgC formation process for forming the AgC layer.

In order for manufacturing the fixed substrate 51, firstly, a resist 61 is provided to the glass substrate as a material of manufacture of the fixed substrate 51 as shown in FIG. 4A (a resist formation process), and then the first groove 62 including the mirror fixation surface 512A is provided thereto as shown in FIG. 4B (a first groove formation process).

Specifically, in the resist formation process, the resist 61 is provided to the bonding surface 513. Subsequently, in the first groove formation process, the portion other than the bonding surface 513, on which the resist 61 is not provided, is etched to thereby form the first groove 62 including the mirror fixation surface 512A.

Further, after forming the first groove 62, the resist 61 is further formed on the first groove 62 at a position where the mirror fixation surface 512A is formed, and then the etching process is further performed (a second groove formation process). Thus, the electrode formation groove 511 and the mirror fixation section 512 are formed as shown in FIG. 4C.

Subsequently, the resist 61 on the fixed substrate 51 is removed, and then the AgC thin film 63 is formed on the surface thereof opposed to the movable substrate 52 so as to have a thickness dimension of, for example, 30 nm (an AgC formation process). Further, in the AgC formation process, the resist 61 is formed on the AgC thin film 63 thus formed at the portions where the fixed mirror 56 and the first displacing electrode 541 are formed.

Further, by removing the AgC thin film 63 on the portions where the resist 61 is not provided, the fixed mirror 56 and the first displacing electrode 541 are formed (an AgC removal process) as shown in FIG. 4D.

According to the processes described above, the fixed substrate 51 is formed.

### 5-2. Manufacture of Movable Substrate

Then, a method of manufacturing the movable substrate 52 will be described.

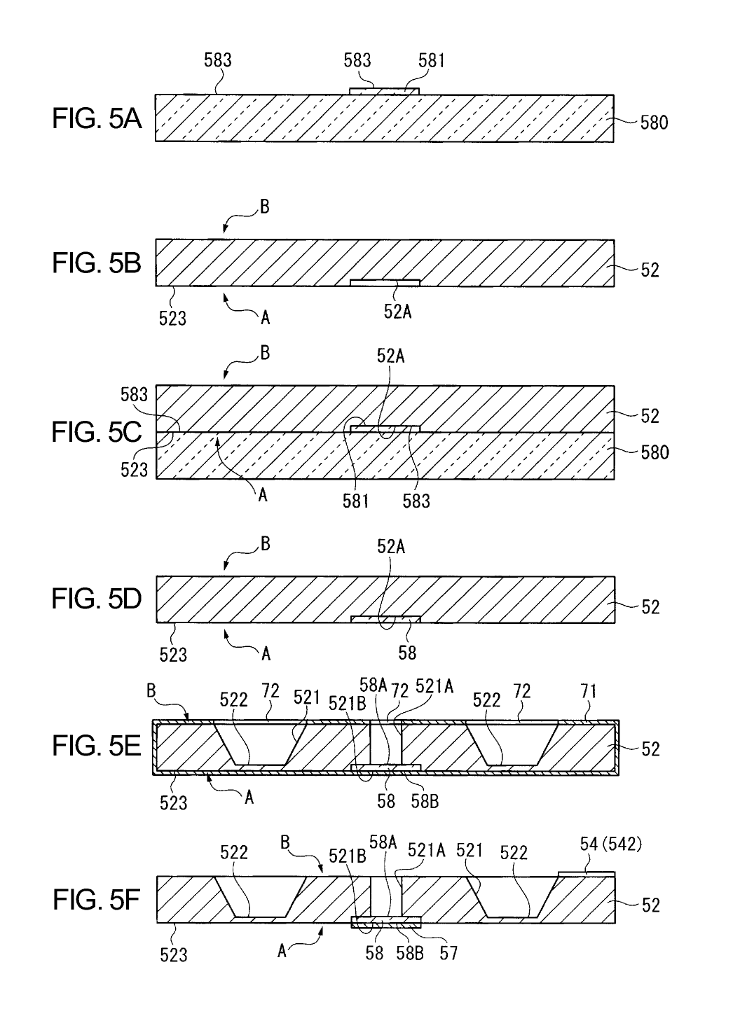

FIGS. 5A through 5F are diagrams schematically showing a manufacturing process of a second substrate, wherein FIG. 5A is a schematic diagram of a glass precursor formation process for forming a glass precursor by etching a transmissive substrate, FIG. 5B is a schematic diagram of a recessed section formation process for forming a recessed section by performing Si-etching using an SiO₂ etching pattern provided to the second substrate, FIG. 5C is a schematic diagram of an anodic bonding process for performing the anodic bonding between the second substrate and the transmissive substrate while fitting the glass precursor and the recessed section to each other, FIG. 5D is a schematic diagram of a polishing process for polishing the transmissive substrate to the bonding surface with the second substrate, FIG. 5E is a schematic diagram of a movable section/connection holding section/light transmission opening formation process for forming a movable section, a connection holding section, and a light transmission opening by performing Si-etching using an SiO₂ etching pattern provided to the second substrate, and FIG. 5F is a schematic diagram of an electrode/mirror formation process for providing a second displacing electrode and a movable mirror.

In the manufacture of the movable substrate 52, firstly, a resist film is formed on the glass substrate 580 at the portion corresponding to the glass member 58 as the transmissive member, and then a portion on which the resist film is not formed is etched to thereby form a glass precursor 581, which turns to the glass member 58 later, as shown in FIG. 5A.

Subsequently, as shown in FIG. 5B, an oxidation treatment is performed on the first surface A of the silicon substrate as a material of manufacture of the movable substrate 52 to thereby form a silicon oxide film. Further, it is preferable that a silicon substrate with the crystal orientation of (100) is used as the silicon substrate, and the thickness of the silicon substrate is equal to or larger than 0.5 mm in order for suppressing the deflection of the movable mirror 57. Subsequently, the silicon oxide film at the position corresponding to the recessed section 52A of the movable substrate 52 is removed to thereby expose the movable substrate 52. The removal of the silicon oxide film can be performed by wet-etching with buffered hydrofluoric acid or the like. Subsequently, by etching the movable substrate 52, the recessed section 52A is formed (a recessed section formation process). In the etching process, the silicon substrate can be etched with potassium hydroxide solution or the like. Further, since the silicon substrate has the crystal orientation of (100), the recessed section 52A having a columnar inner peripheral surface and a bottom surface parallel to the first surface A can be formed by etching.

After the recessed section formation process, as shown in FIG. 5C, the movable substrate 52 provided with the recessed section 52A and the glass substrate 580 provided with the glass precursor 581 are made to face each other, and then the movable substrate 52 and the glass substrate 580 are bonded to each other by anodic bonding (an anodic bonding process). When bonding them by anodic bonding, for example, the glass substrate 580 is connected to a minus terminal of a direct current power supply not shown, and the movable substrate 52 is connected to a plus terminal of the direct current power supply not shown. After then, when a voltage of 500V is applied while heating the glass substrate 580 to, for example, 300° C., movable ions in the glass substrate 580 become easy to migrate due to the heating process. Due to the migration of the movable ions, a bonding surface 583 of the glass substrate 580 is charged negatively while a bonding surface 523 of the movable substrate 52 is charged positively. As a result, the glass substrate 580 and the movable substrate 52 are firmly bonded to each other.

After the anodic bonding process, the glass substrate 580 is polished as shown in FIG. 5D (a glass substrate polishing process). The polishing process is performed until the first surface A of the movable substrate 52 is exposed. Specifically, the polishing process is performed so that the light exit surface 58B and the first surface A become coplanar with each other, and the surface roughness Ra thereof is arranged to be equal to or smaller than 1 nm.

As shown in FIG. 5E, after the glass substrate polishing process, a silicon oxide film 71 is formed on the surface of the movable substrate 52, then the silicon oxide film 71 at the positions corresponding to the light transmission opening 521A and the connection holding section 522 of the movable substrate 52 is removed, and thus the etching pattern 72 is formed to thereby expose the movable substrate 52. Subsequently, by etching the movable substrate 52, the light transmission opening 521A and the connection holding section 522 are formed (a light transmission opening/connection holding section formation process). Further, in order for making the connection holding section 522 act as a diaphragm, it is required to etch it until the thickness thereof is reduced to about 0.1 mm. In the case of etching a part of a quartz substrate having a thickness of 0.5 mm with buffered hydrofluoric acid until the thickness is reduced to 0.1 mm, it takes 50 hours or more. In contrast, in the case of etching the silicon substrate with potassium hydroxide solution, the treatment can be completed in about 2.5 hours. According to the fact described above, it is vary advantageous to use the silicon substrate for the movable substrate 52.

Finally, as shown in FIG. 5F, all of the silicon oxide film on the surface of the movable substrate 52 provided with the light transmission opening 521A and the connection holding section 522 is removed, then the second displacing electrode 542 is disposed on the second surface B of the movable substrate 52, and then the movable mirror 57 is disposed on the movable mirror surface 521B (an electrode/mirror formation process). Thus, the movable substrate 52 can be formed.

### 5-3. Manufacture of Etalon

Then, the manufacture of the etalon 5 using the fixed substrate 51 and the movable substrate 52 manufactured as described above will be explained.

In the manufacture of the etalon 5, a bonding process for bonding the fixed substrate 51 and the movable substrate 52 is performed. In the bonding process, in the condition in which the bonding surface 513 of the fixed substrate 51 and the bonding surface 523 of the movable substrate 52 face each other, the fixed substrate 51 and the movable substrate 52 are bonded to each other by anodic bonding or the like.

When bonding them by anodic bonding, for example, the fixed substrate 51 is connected to a minus terminal of a direct current power supply not shown, and the movable substrate 52 is connected to a plus terminal of the direct current power supply not shown. After then, when applying a voltage to the fixed substrate 51 while heating the fixed substrate 51, sodium ions in the fixed substrate 51 become easy to migrate due to the heating process. Due to the migration of the sodium ions, a bonding surface 513 of the fixed substrate 51 is charged negatively while the bonding surface 523 of the movable substrate 52 is charged positively. As a result, the fixed substrate 51 and the movable substrate 52 are firmly bonded to each other.

It should be noted that although in the present embodiment the glass member 58 is used as the transmissive member, the transmissive member is not limited thereto, but a transmissive resin material can also be used. In other words, any member having light transmissive property can also be used therefor.

Further, although in the present embodiment the silicon substrate is used as the movable substrate 52, the substrate is not limited thereto, but any substrate having conductivity and easily processed and formed by etching can also be adopted.

### 6. Functions and Advantages of Embodiment

In the present embodiment the electrostatic actuator 54 deflects the movable substrate 52 to come closer to the fixed substrate 51, thereby varying the inter-mirror gap G between the fixed mirror 56 and the movable mirror 57. On this occasion, it results that the distortion is caused in the shape of the light transmission opening 521A due to the deflection of the movable substrate 52. Specifically, the light transmission opening 521A is distorted in a direction of increasing the diameter thereof on the side of the first surface A while decreasing the diameter thereof on the side of the second surface B.

On this occasion, since the glass member 58 is not provided to the side of the second surface B of the light transmission opening 521A of the movable substrate 52, the movable substrate 52 can be distorted without any restriction even if the movable substrate 52 is distorted in the direction of decreasing the diameter thereof. Therefore, there is no possibility of causing the problem that the glass member 58 is damaged due to the pressing force in the inward radial direction acting on the glass member 58. Therefore, a longer operating life of the etalon 5 can be achieved.

Further, since it results that the plate-like glass member 58 disposed on the side of the first surface A of the light transmission opening 521A receives tensile stress from the movable substrate 52, there is no possibility of causing the deflection or distortion. Therefore, there is no possibility of causing the variation in the inter-mirror gap G between the fixed mirror 56 and the movable mirror 57. Therefore, the spectral accuracy of the etalon 5 can be maintained.

Therefore, according to the present embodiment, the etalon 5 with high accuracy and longer life can be obtained.

According to the present embodiment, it is possible to prevent the deflection of the movable mirror 57, and to maintain the parallel relationship between the fixed mirror 56 and the movable mirror 57. Specifically, if the movable substrate 52 is deflected toward the fixed substrate 51, there is a possibility of causing a gap or a step between the light exit surface 58B of the glass member 58 and the first surface A of the movable substrate 52. Therefore, in the case in which the movable mirror 57 is formed so as to straddle the light exit surface 58B of the glass member 58 and the first surface A of the movable substrate 52, there is a possibility that the movable mirror 57 is distorted due to the gap or the step described above, which hinders the parallel relationship with the fixed mirror 56 from being maintained. In contrast thereto, by disposing the movable mirror 57 in the plane of the light exit surface 58B of the glass member 58 as in the present embodiment, even if the gap or the step described above is caused, the gap or the step does not have any influence thereon, and the movable mirror 57 is never deflected.

Further, although the first surface A forms a downwardly-convex quadratic surface when the movable substrate 52 is deflected, by using a material with a hardness higher than the movable substrate 52 such as the glass member 58 as the transmissive member, it becomes also possible to efficiently prevent the distortion in the light exit surface 58B and the light entrance surface 58A of the transmissive member. In this case, by disposing the movable mirror 57 in the light exit surface 58B of the transmissive member, the distortion of the movable mirror 57 can also be prevented, and improvement of the spectral accuracy can be achieved.

According to the present embodiment, since the recessed section 52A is provided to the light transmission opening 521A on the side of the first surface A, and the glass member 58 is housed in the recessed section 52A, the glass member 58 can be prevented from protruding from the first surface A of the movable substrate 52. Therefore, in the initial state in which the movable substrate 52 is not deflected toward the fixed substrate 51, the dimension of the inter-mirror gap G can be set larger to make it possible to disperse the light beam in a broader wavelength range.

According to the present embodiment, in the case of separately assembling the movable substrate 52 and the glass member 58 from each other, in order for forming the light exit surface 58B parallel to the fixed mirror 56, the first surface A of the movable substrate 52 is formed to be parallel to the fixed mirror 56, and then the glass member 58 provided to the movable substrate 52 is attached so as to be parallel to the fixed mirror 56, as a result. However, since in the present embodiment the light exit surface 58B and the first surface A of the movable substrate 52 are coplanar with each other, if, for example, the glass member 58 is attached to the movable substrate 52 and then the movable substrate 52 and the glass member 58 are polished so that the first surface A and the light exit surface 58B become parallel to the fixed mirror 56, it is not required to separately mount the movable substrate 52 and the glass member 58 so as to be parallel to the fixed mirror 56, but it is sufficient to polish them so as to become parallel to the fixed mirror 56. Therefore, the etalon 5 can easily be manufactured, and the productivity can be improved.

According to the present embodiment, since the movable substrate 52 and the glass member 58 are bonded to each other by anodic bonding, the movable substrate 52 and the glass member 58 can be bonded directly to each other. Therefore, there is no possibility that the movable substrate 52 and the glass member 58 become nonparallel to each other due to the thickness variation in the adhesive layer, which is caused in the case of bonding them with an adhesive or the like, and thus the distortion is not caused in the parallel relationship between the fixed mirror 56 and the movable mirror 57. Therefore, according to the invention, the spectral accuracy can be maintained with better accuracy.

According to the present embodiment, since the fixed substrate 51 and the movable substrate 52 are bonded to each other by anodic bonding, the fixed substrate 51 and the movable substrate 52 can be bonded directly to each other. Therefore, there is no possibility that the fixed substrate 51 and the movable substrate 52 become nonparallel to each other due to the thickness variation in the adhesive layer, which is caused in the case of bonding them with an adhesive or the like, and thus the distortion is not caused in the parallel relationship between the fixed mirror 56 and the movable mirror 57. Therefore, according to the invention, the spectral accuracy can be maintained with better accuracy.

In the present embodiment, silicon is selected as a material of the movable substrate 52. Silicon can be etched easily and promptly by crystal anisotropic etching compared to, for example, glass or the like, and can be etched with accuracy by anisotropic etching. Therefore, by selecting silicon as the material of the movable substrate 52, improvement of the etching accuracy and reduction of the etching time can be achieved when performing etching on the movable substrate 52.

Therefore, it becomes easy to process the movable substrate 52, and the productivity of the etalon 5 can be improved.

As described above, since in the present embodiment the etalon 5 is not provided with the glass member disposed on the second surface B of the movable substrate 52 at the light transmission opening 521A, there is no possibility that the glass member 58 is broken due to the pressing force acted on the glass member 58 in the inward radial direction caused by the stress concentration. Further, there is no possibility that the deflection or the distortion is caused in the glass member 58. Further, there is no possibility that the variation is caused in the inter-mirror gap G between the fixed mirror 56 and the movable mirror 57. Therefore, the spectral accuracy of the etalon 5 can be maintained.

By receiving the light beam emitted from such an etalon 5 by the light receiving element 31, the optical sensor 3 can measure the accurate light intensity of the light component with a desired wavelength included in the test target light beam.

Since in the present embodiment the etalon 5 is not provided with the glass member 58 disposed on the second surface B of the movable substrate 52 at the light transmission opening 521A, there is no possibility that the glass member 58 is broken due to the pressing force acted on the glass member 58 in the inward radial direction caused by the stress concentration. Further, there is no possibility that the deflection or the distortion is caused in the glass member 58. Further, there is no possibility that the variation is caused in the inter-mirror gap G between the fixed mirror 56 and the movable mirror 57. Therefore, the spectral accuracy of the etalon 5 can be maintained, and in the light receiving element 31 of the optical sensor 3, the light intensity of the light beam with a desired wavelength included in the test target light beam can accurately be detected. Therefore, also in the control device 4, analysis can be performed with accuracy based on the accurate light intensity of the light beam with the desired wavelength included in the test target light beam.

### MODIFIED EXAMPLES

It should be noted that the invention is not limited to the embodiment described above but includes modifications and improvements within a range where the advantages of the invention can be achieved.

Although as an example of the movable substrate 52 there is shown the substrate having a conducting property made of silicon, other substrates can also be adopted. On this occasion, a substrate which does not have a conducting property can also be used, and in that case, by depositing an iron film at the bonding position with the fixed substrate 51 and at the bonding position with the glass member 58, it is possible to perform bonding between the movable substrate 52 and the fixed substrate 51, and bonding between the movable substrate 52 and the glass member 58 by fusion bonding using, for example, YAG laser irradiation. Besides the above, in the case in which the movable substrate 52 does not have a conducting property, there can also be adopted a configuration of performing bonding between the movable substrate 52 and the fixed substrate 51 and bonding between the movable substrate 52 and the glass member 58 by, for example, an adhesive.

Although as an example of the analytical instrument, the device for measuring the intensity of the light beams of the respective wavelengths included in the test target light beam is cited, the invention can also be applied to other devices. The invention can be applied to, for example, a device, in a system for providing data corresponding to the light intensity to the light beams of the respective wavelengths to thereby communicate the data with light beams such as an optical apparatus used for a communication section, for extracting the light beam with a predetermined wavelength by the etalon, and then retrieving the data included in the light beam, a device for detecting the absorption wavelength of the light beam by a gas to thereby determine the type of the gas, and so on.

Further, it is also possible to adopt a configuration in which a silicon substrate is also used for the fixed substrate 51, and similarly to the movable substrate, the light transmission opening 521A is formed at the position corresponding to the movable mirror, and a plate-like glass member for closing the light transmission opening 521A is provided. Thus, the etching process of the fixed substrate 51 becomes easy. Since the mirror fixation section of the fixed substrate 51 is not displaced, the plate-like glass member can also be disposed on the surface opposed to the movable substrate 52, or can also be disposed on the surface on the light exit side out of the surfaces of the fixed substrate 51. Further, the configuration of fitting a glass member inside the light transmission opening 521A can also be adopted.

Further, the configuration of providing both of the fixed substrate 51 and the movable electrode 52 with movable sections, and providing the both with the light transmission openings 521A can also be adopted, and in this case, the glass members are formed on the respective surfaces opposed to each other.

Although the most preferable configurations for putting the invention into practice are hereinabove explained specifically, the invention is not limited thereto. In other words, although the invention is particularly illustrated and described with respect mainly to specific embodiments, those skilled in the art can apply various modifications and improvements to the embodiments described above within the scope, the spirit, the technical concepts, or the object of the invention.

The entire disclosure of Japanese Patent Application No. 2010-034380, filed Feb. 19, 2010 is expressly incorporated by reference herein.

What is claimed is:

1. A variable wavelength interference filter comprising:
a first substrate having a light transmissive property;
a second substrate opposed to and bonded to one surface of the first substrate;
a first reflecting film disposed on the one surface of the first substrate;
a second reflecting film disposed on a first surface of the second substrate opposed to the first substrate, and opposed to the first reflecting film via a gap; and
a variable section adapted to vary the gap,
wherein the second substrate includes
a light transmission opening disposed at a position opposed to the first reflecting film, and penetrating through the second substrate from the first surface to the second surface on the opposite side, and
a planar transmissive member opposed to the first substrate and adapted to close the light transmission opening.

2. The variable wavelength interference filter according to claim 1, wherein
the second reflecting film is disposed in a plane of a surface opposed to the first substrate of the transmissive member.

3. The variable wavelength interference filter according to claim 1, wherein
the first surface of the second substrate is provided with a recessed section adapted to house the transmissive member, formed along a circumferential edge of the light transmission opening, and
a plane of the transmissive member opposed to the first substrate and the first surface of the second substrate are coplanar with each other.

4. The variable wavelength interference filter according to claim 1, wherein
the transmissive member is made of glass having a movable ion,
the second substrate has a conductive property, and
the transmissive member and the second substrate are bonded to each other by anodic bonding.

5. The variable wavelength interference filter according to claim 1, wherein
the first substrate is made of glass having a movable ion,
the second substrate has a conductive property, and
the first substrate and the second substrate are bonded to each other by anodic bonding.

6. The variable wavelength interference filter according to claim 1, wherein
the second substrate is made of silicon.

7. An optical sensor comprising:
the variable wavelength interference filter according to claim 1; and
a light receiving section adapted to receive a test target light beam transmitted through the variable wavelength interference filter.

8. An optical sensor comprising:
the variable wavelength interference filter according to claim 2; and
a light receiving section adapted to receive a test target light beam transmitted through the variable wavelength interference filter.

9. An optical sensor comprising:
the variable wavelength interference filter according to claim 3; and
a light receiving section adapted to receive a test target light beam transmitted through the variable wavelength interference filter.

10. An optical sensor comprising:
the variable wavelength interference filter according to claim 4; and
a light receiving section adapted to receive a test target light beam transmitted through the variable wavelength interference filter.

11. An optical sensor comprising:
the variable wavelength interference filter according to claim 5; and
a light receiving section adapted to receive a test target light beam transmitted through the variable wavelength interference filter.

12. An optical sensor comprising:
the variable wavelength interference filter according to claim 6; and
a light receiving section adapted to receive a test target light beam transmitted through the variable wavelength interference filter.

13. An analytical instrument comprising the optical sensor according to claim 7.

14. An analytical instrument comprising the optical sensor according to claim 8.

15. An analytical instrument comprising the optical sensor according to claim 9.

16. An analytical instrument comprising the optical sensor according to claim 10.

17. An analytical instrument comprising the optical sensor according to claim 11.

18. An analytical instrument comprising the optical sensor according to claim 12.
